(19) United States
(12) Patent Application Publication
(10) Pub. No.: US 2003/0236016 A1
(43) Pub. Date: Dec. 25, 2003

(54) Tubular bus bar, insulating coating method therefor, and insulating coating structure therefor

(75) Inventors: Masakazu Murakami, Tokyo (JP); Hideyuki Fujinami, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: The Furukawa Electric Co., Ltd., Tokyo (JP)

(21) Appl. No.: 10/463,101

(22) Filed: Jun. 17, 2003

(30) Foreign Application Priority Data
Jun. 20, 2002 (JP) 2002-180154

(51) Int. Cl. H01R 4/60

(52) U.S. Cl. 439/212

(57) ABSTRACT

A tubular bus bar is comprised of a conductive pipe member that is three-dimensionally bent, and first and second connections that are provided, e.g., at both ends of the pipe member. The pipe member is covered with an insulating tube, except for those portions at which the first and second connections are formed. The tubular bus bar is lightweight, easy to be recycled, high in power transfer efficiency, and easy to be assembled to an electrical equipment.

### BACKGROUND

1. Technical Field

The present invention relates to a tubular bus bar for electrical connection in automobiles, electric railcars, aircrafts, household electric appliances, fuel cell utilities, etc., and more particularly, to a tubular bus bar suited to establish electrical connection between automobile-mounted electrical components. Also, the present invention relates to an insulating coating method and an insulating coating structure for a tubular bus bar.

2. Related Art

In the field of electric vehicle, hybrid vehicle, fuel battery vehicle, etc., wire-twisted cables and bus bars are employed for electrical connection between vehicle-mounted components such as battery, inverter and motor. Heretofore, bus bars of this kind are constituted by a heavy-sectioned or plate-like solid conductor made of copper, aluminum or an aluminum-alloy. A plate-like bus bar is described in JP-A-10-336842, for instance.

Bus bars remain uninsulated or are insulated to prevent short-circuit, depending whether they are disposed in use to be spaced from or in close proximity to one another. For an insulated bus bar, insulation is provided by winding insulating paper in layer around the bus bar until a required thickness is built up, or by inserting the bus bar into a relatively thick-walled heat shrinkable insulating tube and subjecting the resultant bar/tube assembly to thermal treatment to fix the insulating tube to the bus bar.

However, the conventional bus bars have drawbacks, and hence there are demands for improvements, as described below.

Since a heavy-sectioned or plate-like bus bar is cut out from a raw material with a low yield, a large amount of waste is produced, and considerable labor is involved in the recycling of waste, resulting in increased costs.

Further, in connecting a heavy-sectioned or plate-like bus bar with electrical equipment, inefficient and laborious operations are needed. This also applies to wire-twisted cables with insulation. Such connecting operations may cause not only poor workability but also erroneous connection. Thus, there is a demand to provide a bus bar having improved workability that positively eliminates erroneous connection, e.g., in connecting bus bars with a three-phase circuit.

As for an insulated bus bar wound with insulating paper, a considerable winding operation must be made to attain desired dielectric strength, which takes much time especially for a bus bar having a complicated three-dimensional shape. As for a bar/tube assembly comprised of a bus bar covered with a relatively thick-walled heat shrinkable tube, the assembly requires a high-priced tube and laborious operations of inserting the bus bar into the tube and subjecting the resultant bar/tube assembly to heat treatment.

An insulating coating structure using insulating paper poses a problem that the insulating paper that is in close contact with a bus bar can prevent heat from dissipating, which is produced by electric current flow in the bus bar. This also applies to an insulating coating structure using a heat shrinkable tube since the tube is in close contact with a bus bar.

With the trend of an increasing conversion frequency of an inverter to improve the conversion efficiency, the skin effect causing a concentrated current flow in a surface layer of a bus bar is noticeable. Thus, the current density in a bus bar becomes lower toward a central portion thereof, resulting in low efficiency of power transfer. This is true for a heavy-sectioned or plate-like bus bar comprised of a solid conductive body, since most portions of the bus bar fail to contribute to power transfer. In this regard, there is a demand to provide a bus bar that permits power transfer at improved efficiency.

The skin effect causes increased AC resistance which may in turn cause heat generation. For heat dissipation, the sectional area size of a bus bar must be increased, resulting in undesired increase of weight.

A bus bar is often installed, together with, e.g., a battery, in a closed space that provides a hostile thermal environment for the bus bar as compared to an open space. For forced cooling, a heat pipe is sometimes provided in the proximity of the bus bar. Such arrangement is disadvantageous in that the number of components increases, resulting in a complicated structure and increased weight and costs.

In the field of electric vehicle, etc., from the view point of easy recycling and improved fuel consumption, it is desired that a vehicle component part, such as a bus bar, is constituted by a single element and light in weight.

### SUMMARY

An object of the present invention is to provide a tubular bus bar that is lightweight, easy to be recycled, and high in power transfer efficiency.

Another object of the present invention is to provide an insulating coating method for a tubular bus bar, which is capable of providing a tubular bus bar with an insulating coating at low costs with simplified operations.

Still another object of the present invention is to provide an insulating coating structure for a tubular bus bar, which is capable of providing a tubular bus bar with improved insulating and heat dissipating properties.

According to one aspect of the present invention, there is provided a tubular bus bar which comprises a tubular member having conductivity and bent three-dimensionally, and first and second connections formed in the tubular member.

A tubular bus bar of this invention mainly comprised of a tubular member is lighter in weight and higher in power transfer efficiency as compared to a conventional bus bar comprised of a solid body, and no substantial waste is produced during the fabrication thereof, thus reducing costs for fabrication of the bus bar and for recycling of waste. Tubular bus bars, formed into one unit with their first connections directed to the same direction and with second connections thereof directed to the same direction, can improve their assembleability to pieces of electrical equipment, thus eliminating erroneous connection thereof.

According to another aspect of this invention, there is provided an insulating coating method for a tubular bus bar, which comprises the steps of: (a) bending a conductive pipe member three-dimensionally and forming first and second connections in the pipe member, to thereby obtain a tubular bus bar; and (b) covering the pipe member with an insulating tube, except for portions of the pipe member in which the first and second connections are already formed or to be formed.

The insulating coating method of this invention makes it possible to provide a tubular bus bar with an insulating coating at low costs with simplified operations.

According to a further aspect of this invention, there is provided an insulating coating structure for a tubular bus bar, which comprises an insulating tube that covers a tubular bus bar comprised of a conductive pipe member that is bent three-dimensional and formed with first and second connections.

The insulating coating structure of this invention makes it possible to provide a tubular bus bar with improved insulating and heat dissipating properties.

### BRIEF DESCRIPTION OF THE DRAWINGS

FIG. 1 is a perspective view showing a tubular bus bar according to an embodiment of this invention;

FIG. 2 is a plan view of the bus bar shown in FIG. 1;

FIG. 3 is a front view of the bus bar;

FIG. 4 is a left side view of the bus bar;

FIG. 5 is a sectional view, taken along line V-V in FIG. 2, of a first terminal that is provided on one side of the bus bar;

FIG. 6 is a sectional view of a second terminal provided on another side of the bus bar, taken along line VI-VI in FIG. 2;

FIG. 7 is a sectional view showing another example of the first terminal of the bus bar;

FIG. 8 is a sectional view showing another example of the second terminal of the bus bar;

FIG. 9 is a fragmentary sectional view of the bus bar shown in FIG. 1, in a state where the bus bar is covered with an insulating coating;

FIG. 10 is a sectional view of the bus bar covered with the insulating coating, taken along line X-X in FIG. 9;

FIG. 11 is an enlarged fragmentary view showing an end portion of the bus bar shown in FIG. 9 and covered with the insulating coating;

FIG. 12 is a plan view showing a bus bar unit that is comprised of three juxtaposed bus bars each corresponding to the one shown in FIG. 1;

FIG. 13 is a front view of the bus bar unit shown in FIG. 12; and

FIG. 14 is a left side view of the bus bar unit.

### DETAILED DESCRIPTION

In the following, a tubular bus bar according to an embodiment of this invention will be explained.

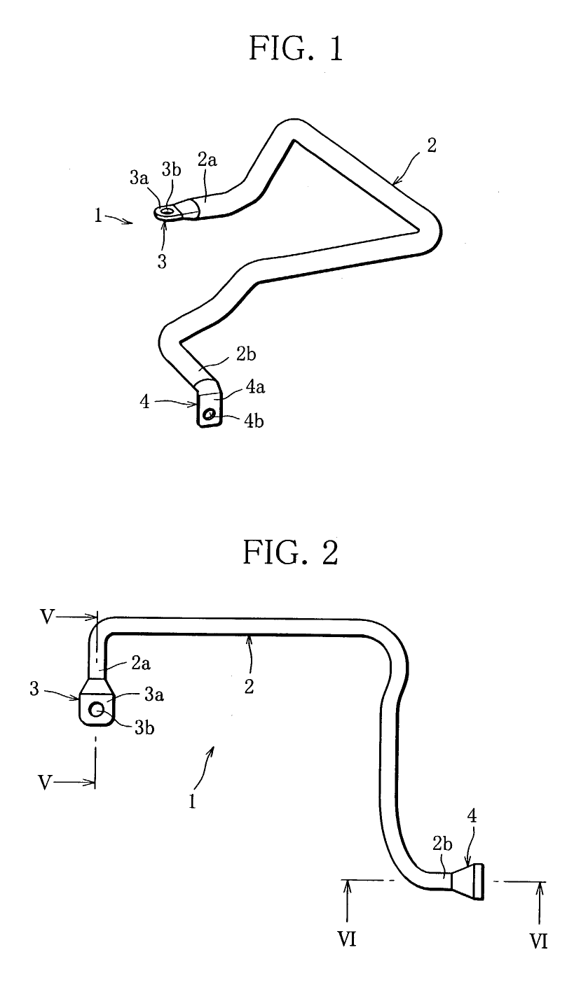

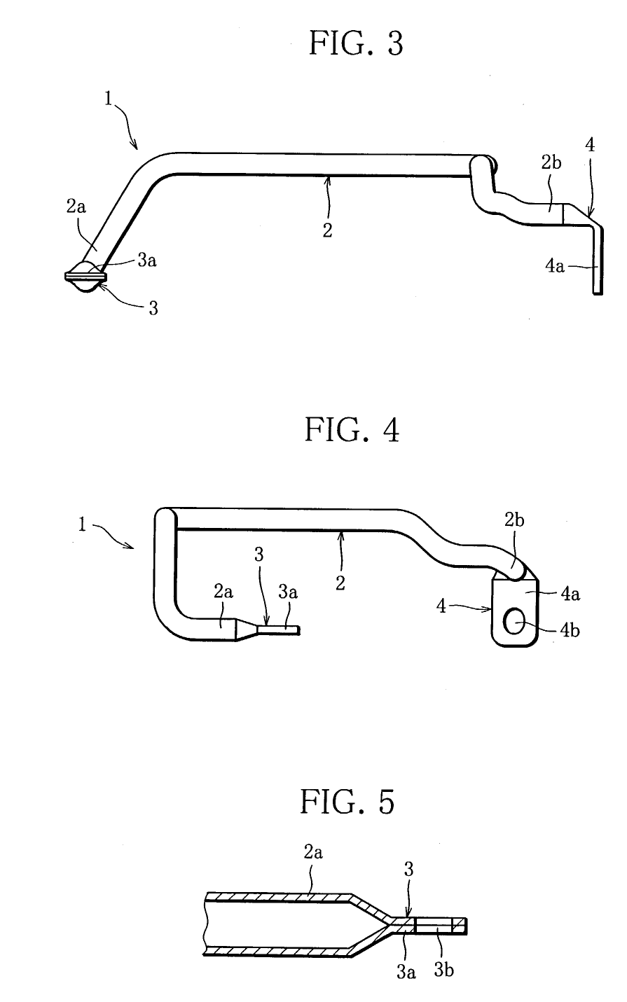

In FIGS. 1-4, reference numeral 1 denotes a bus bar used to establish electrical connection between a battery and an inverter or other electrical component of an electric vehicle, for instance. The bus bar 1 is obtained by bending a pipe member 2 three-dimensionally in accordance with a shape of installation space for the bus bar. In this embodiment, the pipe member 2 is as a whole an L-shape as viewed from above (FIG. 2) and a flattened U-shape as viewed from front (FIG. 3). Preferably, the pipe member 2 has a circular section to make it easy for the pipe member to be bent to arbitrary directions. However, it may be ellipsoidal or polygonal in cross section.

The pipe member 2 is made of aluminum or aluminum alloy which is lightweight and excellent in conductivity, and is provided at its both end portions 2a, 2b with first and second terminals 3, 4 serving as first and second connections, respectively. The pipe member may be constituted by cupper.

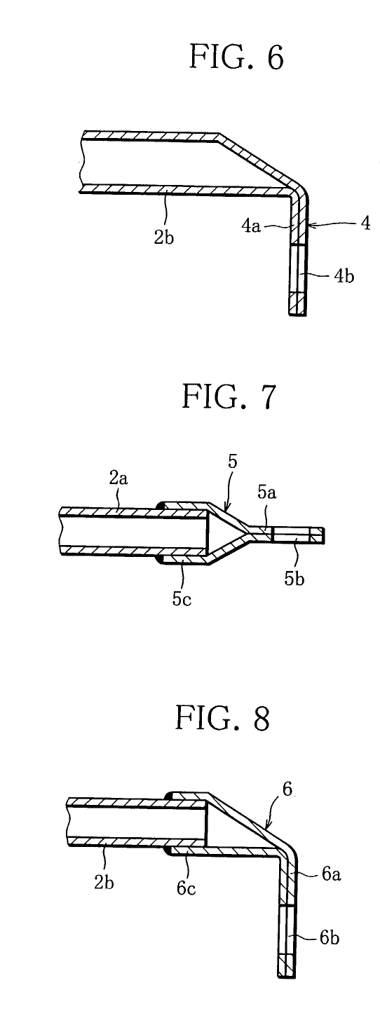

As shown in FIGS. 1 and 5, the first terminal 3 has a flattened portion 3a thereof formed by pressing a distal end of one end portion 2a of the pipe member 2 flat. The flattened portion 3a is formed with a mounting hole 3b. Similarly, as shown in FIGS. 1 and 6, a flattened portion 4a of the second terminal 4 is formed by pressing a distal end of another end portion 2b of the pipe member 2 flat, and is formed with a mounting hole 4b. The flattened portion 4a of the second terminal 4 is bent downward substantially at right angles with respect to a proximal portion of the terminal 4.

Either one of the mounting holes 3b, 4b (e.g., the mounting hole 4b) is formed into an elongated hole for adjustable mounting of the bus bar. Of course, both the mounting holes 3b, 4b may be formed into elongated holes.

As mentioned above, the terminals 3, 4 are formed integrally with the end portions 2a, 2b of the pipe member 2, whereby the bus bar 1 can be constituted by a single pipe member, resulting in reduced fabrication costs.

Meanwhile, the terminals 3, 4 may be fabricated separately from the pipe member 2 and fixed to the end portions 2a, 2b of the pipe member 2. For instance, two auxiliary pipes serving as terminals 5, 6 are prepared each of which is made of the same material as that of the pipe member 2 and has an inner diameter slightly larger than the outer diameter of the pipe member 2. Then, as shown in FIGS. 7 and 8, respective one end portions of the two auxiliary pipes are pressed flat, to thereby form flattened portions 5a, 6a in which mounting holes 5b, 6b are formed, respectively. These auxiliary pipes are fixed by welding to the pipe member 2, with their pipe portions 5c, 6c fitted on the end portions 2a, 2b of the pipe member 2, respectively.

In this embodiment (FIGS. 1, 5 and 6) and its modification (FIGS. 7 and 8), mounting holes are formed in terminals 3, 4 and 5, 6, so that these terminals may be fixed to electrical components by using bolts that are inserted through the mounting holes. However, it is not inevitably necessary to provide the terminals with such mounting holes. For instance, a distal end portion of a terminal may be formed into a bifurcated shape or formed with a notch, so that the distal end portion may be inserted into or caulked to a connection of a corresponding electrical component. If necessary, a terminal may be fixed by welding, etc., to a connection of an electrical component.

As mentioned previously, a large high-frequency electric current flows through a bus bar used for an inverter of an electric vehicle. In this case, due to the skin effect, the current density is high in vicinity of the surface of the bus bar, but is low at a central part thereof. On this point, a conventional heavy-sectioned or plate-like bus bar comprised of a solid conductor may be poor in current capacity and may cause heat generation. Contrary to this, the pipe bus bar 1 of this embodiment comprised of the hollow pipe member 2 can provide a higher current capacity, given the same sectional area, thus making it easy to make the bus bar compact. Further, the tubular bus bar 1 having a larger surface area has a higher efficiency of heat release, making it further easy to attain a compact-sized bus bar.

The tubular bus bar 1 can be fabricated without producing waste, by determining the thickness and outer diameter of the pipe member 2 in accordance with the required current capacity of the bus bar 1, whereby fabrication costs can be reduced substantially.

Preferably, as first requirements, the bus bar 1 is enabled to be formed by bending into a complicated three-dimensional shape that is convenient for installing the bus bar, e.g., in a bus-bar installation space in an electric vehicle and for attaching the bus bar to a battery or an inverter, is lightweight, and has an adequate current capacity.

To permit the bus bar 1 to meet the first requirements, the pipe member 2 preferably satisfies second requirements which are, by way of example, as follows:

1. The pipe member has an outer diameter and thickness and must be constituted by materials such as to be able to prevent occurrences of crack and wrinkle during the bending process.

2. The pipe member has an outer diameter and sectional area size that can provide the desired current capacity.

3. The pipe member has an outer diameter and thickness that permit collapse deformation of the pipe member upon formation of flattened terminals 3, 4.

4. The pipe member has a volume small enough to permit the bus bar to be received in a bus-bar installation space.

5. The pipe member has a sufficient mechanical strength.

The present inventors made extensive studies on the outer diameter, thickness, and constituent materials. As a result, it was found that pipe members 2, having an outer diameter not less than 6 mm and not greater than 20 mm and a thickness not less than 1 mm and not greater than 4 mm and made of aluminum or an aluminum alloy that is light in weight and excellent in conductivity, satisfy the second requirements, and that bus bars 1 constituted by such pipe members 2 satisfy the first requirements.

For instance, the thickness may be about 1 mm for a pipe member having about 6 mm outer diameter, whereas the thickness may be about 3 mm for a pipe member which is 20 mm in outer diameter. If necessary, those portions of the pipe member, to which terminals 3, 4 are to be formed, may be softened in advance to have a proper hardness.

On the other hand, a pipe member having an outer diameter less than 6 mm provides a smaller ratio of its hollow portion to its wall portion, making it difficult for the pipe member to be pressed flat and to be bent, and provides an insufficient surface area size, resulting in a poor efficiency of heat dissipation. A pipe member having an outer diameter larger than 20 mm poses problems that a difficulty is encountered in installing the pipe member in a narrow space as in an automobile and that a large scale bending machine is required, resulting in increased costs.

A pipe member having a thickness less than 1 mm fails to provide a sufficient current capacity, and makes the thickness of terminals excessively thin to fail to provide the desired mechanical strength. A pipe member having a thickness larger than 4 mm poses problems that cracks and/or winkles are caused in the pipe member during the pressing and/or bending process, and that the weight of the pipe member excessively increases.

In general, a pipe member having a large surface area size as compared to that of a solid member can suppress a temperature rise by means of heat dissipation. However, a pipe member made of aluminum or an aluminum alloy has a metallic luster on the surface thereof in a new article condition, thus providing a thermal emittance of about 0.05-0.1 and being liable to increase in temperature depending on external conditions.

No special surface treatment is required in a case where the surface of a pipe member is exposed to the atmosphere for a long time to receive direct sunlight, rainfall, snowfall, etc., so that the metallic luster on the surface disappears due to adhered dust or surface corrosion to an extent that the surface changes to gray or dark gray in color. On the other hand, for a pipe member used in a closed or semi-closed space in an electric vehicle so that metallic luster on the surface is kept maintained for a long time, surface treatment is preferably made in advance to increase the thermal emittance.

To this end, the surface of the pipe member 2 undergoes, e.g., a dulling treatment to increase the thermal emittance to be not less than 0.7, after the pipe member 2 is subject to bending, or after terminals 3, 4 are formed, or after or before terminals 5, 6 are fixed to the pipe member by welding. By increasing the thermal emittance to about 0.7-0.9, it is possible to lower the pipe member temperature by 30 degrees to 70 degrees centigrade depending on environmental conditions, whereas a pipe member without the dulling treatment can increase in temperature to about 150 degrees centigrade. For this reason, a smaller-sized pipe member can be adopted, thus making it possible to attain a compact bus bar at low costs.

The dulling treatment for an aluminum or aluminum alloy pipe member can be made by the following methods:

1. Subject the pipe member to sand blasting.

2. Subject the pipe member to boehmite treatment, thus forming a gray oxide film on the surface of the pipe member (For instance, the pipe member is placed, for 10 to 30 minutes, in alkaline solution of pH 10 boiled at about 100 degrees centigrade).

3. Subject the pipe member to chemical conversion coating treatment (alodine, zinchosphate, MBW, etc.), thereby forming a gray or dark gray oxide film on the surface of the pipe member.

4. Apply pain to the pipe member (For use with a three-phase circuit, preferably, different color paints such as red, black, green are applied).

The aforementioned surface treatment may be applied to part or the entire of the surface of the pipe member 2.

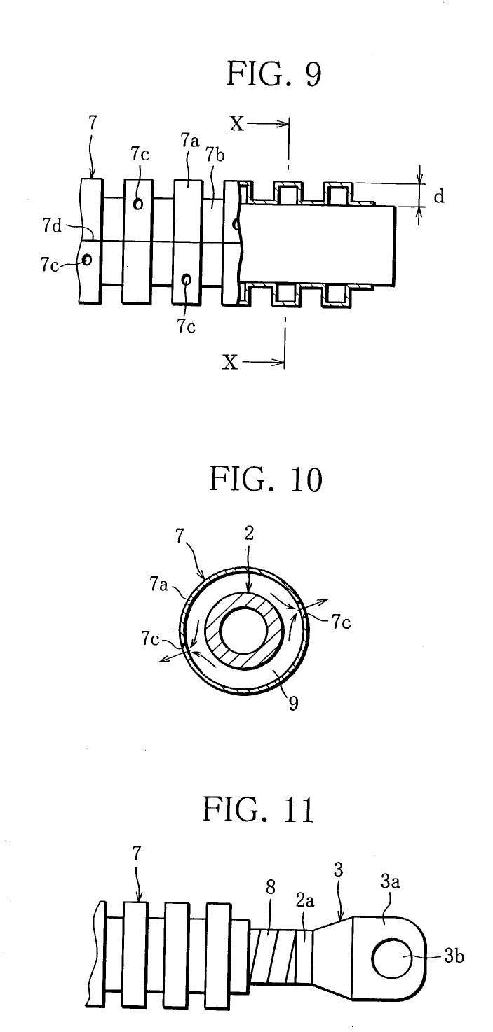

Referring to FIGS. 9 and 10, an insulating coating method for the pipe member 2 of the tubular bus bar 1 will be explained.

A corrugated tube 7, serving as an insulating tube, is a thin tube made of insulating resin on which peaks and valleys 7a, 7b are alternately formed. The valley 7b has its inner diameter slightly larger than the outer diameter of the pipe member 2, and the peak 7a is formed with vent holes 7c at random positions.

The corrugated tube 7 is shorter in length than the pipe member 2 by the lengths of terminals 3, 4 of the pipe member. The pipe member 2 is inserted into the corrugated tube 7 after it is bent into a predetermined three-dimensional shape as shown in FIGS. 1-4, whereby the pipe member 2 is insulated by the corrugated tube 7. Next, both end portions 2a, 2b of the pipe member are pressed flat, thus forming the terminals 3, 4. The flattened terminals 3, 4 are wider in width than a main portion of the pipe member 2, and therefore, the insertion of the pipe member 2 into the corrugated tube 7 is made, preferably prior to the formation of the terminals 3, 4 as mentioned above.

In the meantime, the corrugated tube 7 has an incision 7d extending in the axial direction over the entire length thereof, so that it is openable circumferentially. Thus, even the pipe member 2 having a complicated three-dimensional shape can be inserted into the opened corrugated tube 7 even after the formation of the terminals 3, 4 in the pipe member.

As shown in FIG. 11, the corrugated tube 7 may be fixed so as to be immovable relative to the pipe member 2, by winding a heat-resistant adhesive tape 8, etc. around end portions of the pipe member 2 (only one end portion 2a is shown in FIG. 11).

As for the thickness of the insulation, the corrugated tube 7 is equivalent to an insulator having a thickness that is equal to the difference (shown by symbol d in FIG. 9) between the outer diameter of the peaks 7a and the inner diameter of the valleys 7b (corresponding to the outer diameter of the pipe member 2).

Heat from the surface of the pipe member 2 is easily dissipated to the outside through annular spaces 9 inside the peaks 7a of the corrugated tube 7 and vent holes 7c formed in the peaks 7a. In addition, the corrugated tube 7 is very thin in thickness as compared to the thickness d of the equivalent insulator. Therefore, heat dissipation from the pipe member 2 to the outside is made at a higher rate.

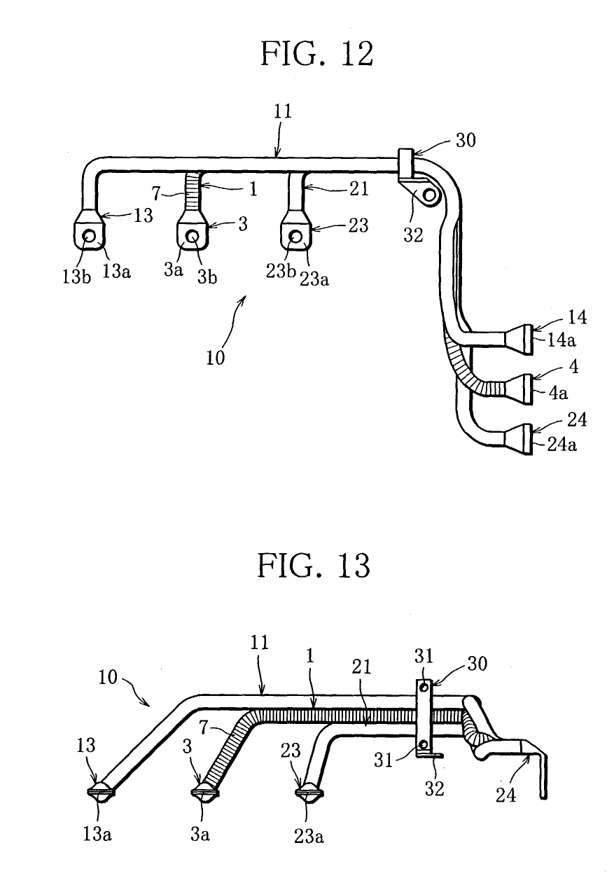

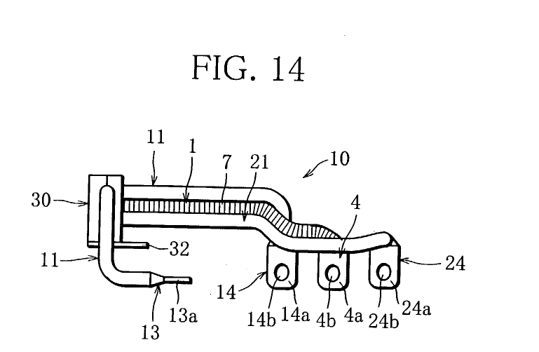

Referring to FIGS. 12-14, a bus bar unit for a three-phase inverter for a drive motor of an electric vehicle.

The bus bar unit 10 comprises a plurality of, e.g., three tubular bus bars (i.e., first, second and third tubular bus bars 1, 11 and 21), and a split insulating jig 30 for holding these bus bars. The insulating jig 30 is provided with a bracket 32 that is fixed to, e.g., a battery casing.

The first bus bar 1 corresponds to the one shown in FIG. 1, and the second and third bus bars 11, 21 are bent three-dimensionally and have their both end portions that are pressed into flattened terminals 13, 14; 23, 24, as in the case of the first bus bar 1.

The split insulating jig 30 consists of first and second halves that are obtained by dividing a thick insulating plate into two pieces along a separating plane passing through three holes formed in the insulating plate. The first and second halves of the jig 30 are fastened together by means of screws 31 in a state that the bus bars 1, 11, 21 extend through three holes of the jig 30, whereby these bus bars are retained by the jig 30. At this time, flattened portions 3a, 13a, 23a of respective one terminals 3, 13, 23 of the bus bars 1, 11, 21 are directed to the same direction. Similarly, flattened portions 4a, 14a, 24a of other terminals 4, 14, 24 are directed to the same direction.

According to the bus bar unit 10 having bus bars 1, 11, 21 that are integrated into one unit and having flattened portions (serving as terminal mounting faces) that are directed to the same direction, the ease of mounting the bus bars to pieces of electrical equipment can be improved, thus eliminating mistakes such as erroneous wiring and substantially reducing costs for assemblage, process control, etc.

It is not indispensably necessary to permanently secure the bus bars 1, 11, 21 to the insulating jig 30. Specifically, the insulating jig 30 may be removed after electrical connection has been once established via the bus bars between pieces of electrical equipment such as battery and inverter, whereby the bus bar unit 10 can be reduced in weight. In a case where the jig is removed after electrical connection is established, a non-insulating jig for temporarily holding the bus bars may be employed instead of using the insulating jig 30.

The present invention is not limited to the foregoing embodiment, and may be modified variously.

For instance, in the embodiment, cases have been explained in which this invention is applied to establish electrical connection between vehicle-mounted electrical components. However, this invention is applicable to establishing electrical connection between electrical components in the field other than the vehicle industry.

Although two terminals serving as first and second connections are provided at both ends of a tubular bus bar in the embodiment, the number of connections is not limited to two, and connection-formed portions of a tubular bus bar is not limited to the ends of the bus bar.

Furthermore, it is not inevitably necessary to constitute a tubular bus bar by means of a single tubular bus bar. Alternatively, it may be constituted in the form of a branch tubular bus bar comprised of two or more tubular bus bars.

For instance, a branch tubular bus bar may be comprised of primary and secondary tubular bus bars each provided at its both ends with first and second connections. The primary bus bar further comprises a third connection that is provided at a middle portion thereof. The respective connections of the bus bars are each formed with a mounting hole. The first connection of the secondary bus bar is formed into a bifurcated shape. The secondary bus bar is fixed to the primary bus bar, with its first connection fitted on the third connection of the primary bus bar, by means of a bolt inserted into the mounting holes formed in these connections.

In other respects, the present invention may be modified within the inventive scope thereof.

What is claimed is:

1. A tubular bus bar comprising:
a tubular member having conductivity and bent three-dimensional; and
first and second connections formed in the tubular member.

2. The tubular bus bar according to claim 1, wherein said first and second connections are formed by pressing corresponding portions of said pipe member flat, respectively.

3. The tubular bus bar according to claim 1, wherein said tubular bus bar and at least one other tubular bus bar, which is the same in construction as said tubular bus bar, are formed into one unit by using a jig, with said first connection of said tubular bus bar and a first connection of said other tubular bus bar directed to the same direction and with said second connection of said tubular bus bar and a second connection of said other tubular bus bar directed to the same direction.

4. The tubular bus bar according to claim 1, wherein said pipe member is made of aluminum or an aluminum alloy.

5. The tubular bus bar according to claim 1, wherein part or whole of an outer peripheral surface of said pipe member has a thermal emittance of 0.7-0.9.

6. The tubular bus bar according to claim 1, wherein said pipe member has an outer diameter not less than 6 mm and not larger than 20 mm, and has a thickness not less than 1 mm and not larger than 4 mm.

7. An insulating coating method for a tubular bus bar, comprising the steps of:
(a) bending a conductive pipe member three-dimensionally and forming first and second connections in the pipe member, to thereby obtain a tubular bus bar; and
(b) covering the pipe member with an insulating tube, except for portions of the pipe member in which the first and second connections are already formed or to be formed.

8. The insulating coating method according to claim 7, wherein said step (a) includes the sub-steps of:
(a1) bending the pipe member three-dimensionally; and
(a2) forming the first and second connections in the pipe after said step (b) is performed.

9. The insulating coating method according to claim 7, wherein the insulating tube is comprised of a corrugated tube having peaks and valleys alternately formed, and the corrugated tube is formed at the peaks with vent holes.

10. An insulating coating structure for a tubular bus bar, comprising:
an insulating tube that covers a tubular bus bar comprised of a conductive pipe member bent three-dimensionally and formed with first and second connections.

11. The insulating coating structure according to claim 10, wherein said insulating tube is comprised of a corrugated tube having peaks and valleys alternately formed, and the corrugated tube is formed at the peaks with vent holes.

12. The insulating coating structure according to claim 10 or 11, wherein said insulating tube covers an intermediate-positioned tubular bus bar of three tubular bus bars that are formed into one unit by using a jig, or covers two tubular bus bars positioned on both sides of the intermediate-positioned tubular bus bar.
